(19) United States
(12) Patent Application Publication
(10) Pub. No.: US 2008/0022982 A1
(43) Pub. Date: Jan. 31, 2008

(54) Variable Compression Ratio Internal Combustion Engine

(75) Inventor: Eiichi Kamiyama, Mishima-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 11/630,862

(22) PCT Filed: Jan. 24, 2006
(86) PCT No.: PCT/JP06/01396

§ 371 Date: Dec. 26, 2006

(30) Foreign Application Priority Data
Jan. 24, 2005 (JP) 2005-015815

(51) Int. Cl. F02B 69/00

(52) U.S. Cl. 123/575

(57) ABSTRACT

The invention is directed to a variable compression ratio internal combustion engine in which the compression ratio of the engine can be varied and multiple types of fuels having different combustion velocities are used. The invention provides a technology for achieving excellent engine performance for respective types of fuels. In the variable compression ratio internal combustion engine in which the compression ratio can be varied and multiple types of fuels having different combustion velocities are injected through multiple fuel injection valves, maps from which a target compression ratio of the internal combustion engine is read out are switched in accordance with the fuel used, thereby suppressing knocking or other disadvantages.

### TECHNICAL FIELD

The present invention relates to a variable compression ratio internal combustion engine in which the compression ratio of the engine can be varied, and in particular to one that uses multiple types of fuels having different combustion velocities.

### BACKGROUND ARTS

In recent years, for the purpose of improving gas mileage, power and other performance capabilities of internal combustion engines, technologies for making the compression ratio of an internal combustion engine variable have been proposed. In an already-proposed technology disclosed for example in Japanese Patent Application Laid-Open Nos. 7-26981 and 2003-206771, the cylinder block and the crankcase are linked in such a way as to be movable relative to each other and a cam shaft is provided in their link portion to move the cylinder block and the crankcase toward/away from each other with turning of the cam shaft.

On the other hand, internal combustion engines that use hydrogen as fuel have drawn attention as a solution for concern for exhaust of fuel resources and influence of carbon dioxide emission on global warming in recent years. In view of limited availability of hydrogen, bi-fuel systems in which both hydrogen and gasoline can be used as fuel have been developed as disclosed for example in Ken Yamane, “Hydrogen Vehicle Development by BMW”, Engine Technology, vol. 5, No. 6, pages 24-29, December 2003, Sankaido. However, in such bi-fuel systems, the compression ratio of the internal combustion engine is fixed, and optimization of the compression ratio has not been done for both the case where use is made of gasoline and the case where use is made of hydrogen as fuel. Therefore, it has been sometimes difficult to achieve sufficient engine performance with both the fuels. A related art is also disclosed in Japanese Patent Application Laid-Open No. 63-159642.

### DISCLOSURE OF THE INVENTION

The present invention has been made taking into consideration the above-described prior arts. The present invention is directed to a variable compression ratio internal combustion engine in which the compression ratio of the engine can be varied and multiple types of fuels having different combustion velocities are used and has as an object to provide a technology for achieving excellent engine performance for respective types of fuels.

To achieve the above object, according to the present invention, there is provided a variable compression ratio internal combustion engine in which the compression ratio of the engine can be varied and multiple types of fuels having different combustion velocities are used. Its principal characterizing feature resides in that it has fuel-suitable compression ratio changing means for changing the compression ratio of the internal combustion engine in accordance with the combustion velocity of the fuel used.

It is known that the likelihood of knocking to occur in internal combustion engines varies depending on the combustion velocity of the fuel used. This is because the lower the combustion velocity is, the higher the possibility that self ignition of fuel occurs at an end of the cylinder of the internal combustion engine before combustion reaches that cylinder end is. For this reason, the limit value of the compression ratio that may be set varies depending on the combustion ratio of the fuel used. Specifically, the higher the combustion ratio of the fuel used is, the higher the compression ratio may be set, and the higher combustion efficiency it is possible to realize. In view of the above, according to the present invention, in a variable compression ratio internal combustion engine in which the compression ratio can be varied and multiple types of fuels having different combustion velocities are used, the compression ratio is changed in accordance with the combustion velocity of the fuel used.

Thus, when multiple types of fuels having different combustion velocities are used, it is possible to choose a compression ratio that is optimum to each fuel and to realize higher combustion efficiency for both fuels.

In the present invention, the above-mentioned multiple types of fuels may include hydrogen and a specific petroleum fuel, and in the case hydrogen is used as fuel, the compression ratio of the internal combustion engine may be made, by said fuel-suitable compression ratio changing means, higher than that in the case where the petroleum fuel is used under the same environmental condition and/or the same running condition.

Here, the specific petroleum fuel refers to gasoline or light oil. In this case, the combustion velocity of hydrogen as fuel is higher than that of gasoline or light oil. Therefore, if the compression ratio of the internal combustion engine is made higher when hydrogen is used as fuel than when the petroleum fuel is used under the same environmental condition and/or the same running condition, it is possible to set optimum compression ratios for the respective fuels. As a result, it is possible to achieve high combustion efficiency for both the case where hydrogen is used as fuel and the case where the specific petroleum fuel is used, while suppressing knocking.

In the present invention, when hydrogen is used as fuel and the running condition of the internal combustion engine falls within a first specific high load range, the fuel-suitable compression ratio changing means may set the compression ratio of the internal combustion engine to such a compression ratio that does not cause in-cylinder pressure of the internal combustion engine to exceed a limit in-cylinder pressure.

It is known that in the case where hydrogen is used as fuel, the combustion velocity is higher and the maximum in-cylinder pressure in the combustion chamber is higher as compared to the case where the specific petroleum fuel is used as fuel. Accordingly, when hydrogen is used as fuel and the compression ratio of the internal combustion engine is relatively high, the maximum vale of the in-cylinder pressure can sometimes become excessively high under a high load running condition, which can adversely affect reliability of mechanical components relating to the cylinder.

In view of this, in the present invention, when hydrogen is used as fuel and the running condition of the internal combustion engine falls within a first specific high load range, the fuel-suitable compression ratio changing means may set the compression ratio of the internal combustion engine to such a compression ratio that does not cause in-cylinder pressure of the internal combustion engine to exceed a limit in-cylinder pressure. By such control, it is possible to avoid deterioration of reliability of mechanical components relating to the cylinder.

Here, the limit in-cylinder pressure is such a threshold in-cylinder pressure of the internal combustion engine beyond which there is a possibility that reliability of mechanical components relating to the cylinder is adversely affected. The limit in-cylinder pressure is determined in advance by experiments or design. The first specific high load range is such a range of the running condition of the internal combustion engine in which there is a possibility that the peak value of the in-cylinder pressure of the internal combustion engine exceeds the aforementioned limit in-cylinder pressure depending on the compression ratio of the internal combustion engine. This range is also determined in advance by experiments.

Specifically, relationship between the running condition of the internal combustion engine (that falls within the aforementioned first high load range) and the maximum compression ratio that does not cause the in-cylinder pressure to exceed the limit in-cylinder pressure under that load may be prepared as a map and the value of the compression ratio corresponding to the running condition of the internal combustion engine may be read out from that map. Thus, the compression ratio of the internal combustion engine may be changed to the compression ratio thus read out. Alternatively, the actual in-cylinder pressure may be detected by an in-cylinder pressure sensor in the case where the running condition of the internal combustion engine falls within the aforementioned first high load range, and the compression ratio may be changed in such a way that the actual in-cylinder pressure does not exceed the limit in-cylinder pressure.

In the present invention, when hydrogen is used as fuel and the running condition of the internal combustion engine falls within a first specific high load range, the fuel-suitable compression ratio changing means may set the compression ratio of the internal combustion engine to a compression ratio that does not cause the in-cylinder pressure of the internal combustion engine to exceed a specific limit in-cylinder pressure, and in addition fuel ignition time may be retarded in the internal combustion engine.

The in-cylinder pressure of the cylinder of the internal combustion engine is basically determined by pressure caused by movement of the piston in the cylinder, and combustion pressure caused by fuel combustion is added to that basic pressure. On the other hand, when hydrogen is used as fuel, since its combustion velocity is high, fuel ignition time is retarded in many cases, as compared to when the specific petroleum fuel is used as fuel. Specifically, the fuel ignition time is set after the top dead center, in many cases.

In the case where the fuel ignition time is after the top dead center, the later the fuel ignition time, the lower the basic pressure caused by piston movement becomes. Therefore, when hydrogen is used as fuel, if the fuel ignition time is retarded, it is possible to ignite fuel in a condition where the basic pressure caused by piston movement is lower. Consequently, the maximum value of the in-cylinder pressure in the internal combustion engine can be made low.

Therefore, in the present invention, when hydrogen is used as fuel and the running condition of the internal combustion engine falls within the first specific high load range, it is possible to keep the in-cylinder pressure lower than the aforementioned limit in-cylinder pressure more reliably by setting the compression ratio of the internal combustion engine to a compression ratio that does not cause the in-cylinder pressure of the internal combustion engine to exceed the specific limit in-cylinder pressure and retarding the fuel ignition time in the internal combustion engine.

In the present invention, when hydrogen is used as fuel and the running condition of the internal combustion engine falls within the first specific high load range, it is possible to set a higher target compression ratio that does not cause the in-cylinder pressure of the internal combustion engine to exceed the specific limit in-cylinder pressure by performing control for decreasing the compression ratio of the internal combustion engine and control for retarding the fuel ignition time in the internal combustion engine in combination. Then, it is possible to achieve higher engine efficiency when hydrogen is used as fuel.

In the present invention, the internal combustion engine may be further provided with a first fuel injection means for injecting fuel directly into a cylinder of the internal combustion engine and a second fuel injection means for injecting fuel into an intake port of the internal combustion engine, and when hydrogen is used as fuel and the running condition of the internal combustion engine falls at least within a second specific high load range, the compression ratio of the internal combustion engine may be made lower in the case where fuel is injected through the first fuel injection means than in the case where fuel is injected through the second fuel injection means under the same environmental condition and/or the same running condition.

When hydrogen is used as fuel, ways of injecting the fuel include injecting fuel directly into the cylinder in order to enhance fuel filling efficiency thereby increasing the output power and injecting fuel into the intake port in order to favorably mixing hydrogen and oxygen. In the case where fuel is directly injected into the cylinder, the maximum value of the in-cylinder pressure upon combustion tends to be higher than that in the case where fuel is injected into the intake port, since the filling amount of fuel is larger and the possibility that fuel does not spread all over the cylinder but concentrates locally is higher in the former case.

In view of the above, in the present invention, when hydrogen is used as fuel and the running condition of the internal combustion engine falls at least within a second specific high load range, the compression ratio of the internal combustion engine may be made lower in the case where fuel is injected directly into the cylinder than in the case where fuel is injected into the intake port under the same environmental condition and/or the same running condition. Then, in the case where fuel is injected directly into the cylinder, it is possible to prevent the in-cylinder pressure from exceeding the aforementioned limit in-cylinder pressure more reliably. Conversely, in the case where fuel is injected into the intake port, it is possible to make the compression ratio higher and to enhance the efficiency of the internal combustion engine.

Here, the aforementioned second high load range is such a range of the running condition of the internal combustion engine in which it is considered that if fuel is injected through the aforementioned first fuel injection means, there is a risk that the maximum in-cylinder pressure can become excessively high depending on the compression ratio. The second high load range is determined in advance by experiments.

In the present invention, when hydrogen is used as fuel and the air-fuel ratio in the internal combustion engine falls within such a first specific air-fuel ratio range in which the amount of NOx emission from the internal combustion engine is larger than a specific limit NOx amount and the amount of NOx emission increases as the air-fuel ratio becomes richer, air-fuel mixture supplied to the cylinder of the internal combustion engine may be made leaner and the compression ratio of the internal combustion engine may be made lower by the fuel-suitable compression ratio changing means, to thereby make the amount of NOx emission smaller than the limit NOx amount.

It is known that when hydrogen is used as fuel and the air-fuel ratio in the internal combustion engine is relatively low, the leaner the air-fuel ratio is, the smaller the amount of NOx generated upon combustion becomes. In addition, it is known that in this case, the lower the compression ratio of the internal combustion engine is, the smaller the amount of NOx generated becomes. Therefore, it is preferred in the present invention that when hydrogen is used as fuel and the air-fuel ratio in the internal combustion engine falls within the first specific air-fuel ratio range in which the amount of NOx emission from the internal combustion engine is larger than the specific limit NOx amount and the amount of NOx emission increases as the air-fuel ratio becomes richer, air-fuel mixture supplied to the cylinder of the internal combustion engine be made leaner and the compression ratio of the internal combustion engine be made lower. Then, it is possible to reduce the amount of NOx generated upon combustion more effectively as compared to the case where air-fuel mixture supplied to the cylinder of the internal combustion engine is simply made leaner. Thus, it is possible to reduce emission more reliably.

Here, the specific limit NOx amount is a limit of the amount of NOx emitted from the internal combustion engine that is allowable judging from a viewpoint concerning environmental pollution.

Similarly, in the present invention, when hydrogen is used as fuel and the air-fuel ratio in the internal combustion engine falls within such a second specific air-fuel ratio range in which the amount of NOx emission from the internal combustion engine is larger than a specific limit NOx amount and the amount of NOx emission decreases as the air-fuel ratio becomes richer, air-fuel mixture supplied to the cylinder of the internal combustion engine may be made richer and the compression ratio of the internal combustion engine may be made lower by the fuel-suitable compression ratio changing means, to thereby make the amount of NOx emission smaller than the limit NOx amount.

It is known that when hydrogen is used as fuel and the air-fuel ratio in the internal combustion engine is relatively high, the richer the air-fuel ratio is, the smaller the amount of NOx generated upon combustion becomes. In addition, as described above, it is known that the lower the compression ratio of the internal combustion engine is, the smaller the amount of NOx generated becomes. Therefore, it is preferred in the present invention that when hydrogen is used as fuel and the air-fuel ratio in the internal combustion engine falls within the second specific air-fuel ratio range in which the amount of NOx emission from the internal combustion engine is larger than the specific limit NOx amount and the amount of NOx emission decreases as the air-fuel ratio becomes richer, air-fuel mixture supplied to the cylinder of the internal combustion engine be made richer and the compression ratio of the internal combustion engine be made lower. Then, it is possible to reduce the amount of NOx generated upon combustion more effectively as compared to the case where air-fuel mixture supplied to the cylinder of the internal combustion engine is simply made richer. Thus, it is possible to reduce emission more reliably.

As described above, in the present invention, when hydrogen is used as fuel and the NOx emission amount is larger than the specific limit NOx amount, air-fuel mixture supplied to the cylinder of the internal combustion engine is made richer or leaner in accordance with the air-fuel ratio range within which the air-fuel ratio of the internal combustion engine falls, and the compression ratio of the internal combustion engine is made lower, thereby reducing the NOx emission amount. Therefore, it is possible to reduce the extent to which air-fuel mixture supplied to the cylinder of the internal combustion engine is made richer or leaner, as compared to the case where the NOx emission amount is reduced simply by making the air-fuel mixture richer or leaner. This means that it is possible to extend the air-fuel ratio range that is allowable in the internal combustion engine in making the NOx emission amount smaller than the limit NOx amount.

In the present invention, the hydrogen as fuel may be stored in a hydrogen tank and injected into the cylinder or the intake port of the internal combustion engine at a certain hydrogen injection pressure, and when hydrogen is used as fuel, the fuel-suitable compression ratio changing means may change the compression ratio of the internal combustion engine in accordance with the hydrogen injection pressure and/or the pressure in the hydrogen tank.

Here, when hydrogen is used as fuel, hydrogen is stored in a hydrogen tank, and fuel supplied from the hydrogen tank is injected into the cylinder or the intake port at a certain hydrogen injection pressure. However, the hydrogen injection pressure can sometimes decrease with a decrease in the amount of hydrogen remaining in the hydrogen tank. If the decrease occurs, there is a possibility that likelihood of knocking to occur changes with the decrease in the amount of hydrogen remaining in the hydrogen tank.

In view of this, in the present invention, the compression ratio of the internal combustion engine may be changed in accordance with the hydrogen injection pressure and/or the pressure in the hydrogen tank to thereby prevent knocking from being caused by a change in the hydrogen injection pressure.

More specifically, it is considered that the lower the hydrogen pressure is, the harder hydrogen spreads in the cylinder and the higher the possibility that fuel concentrates locally is, and accordingly the more likely knocking occurs. Therefore, the lower the hydrogen injection pressure is, the lower the compression ratio is made, thereby suppressing knocking. Thus, it is possible to prevent knocking from being caused by a change in the fuel injection pressure with a decrease in the amount of hydrogen in the hydrogen tank.

The above-described various means for solving the problem according to the present invention may be applied in any possible combination. Among the above-described various means for solving the problem according to the present invention, those which can be applied to internal combustion engines that use only hydrogen fuel may be applied to such internal combustion engines.

### BRIEF DESCRIPTION OF THE DRAWINGS

FIG. 1 is an exploded perspective view showing the basic structure of an internal combustion engine according to an embodiment of the present invention.

FIG. 2 is a cross sectional view showing a process of movement of a cylinder block relative to a crankcase in the internal combustion engine according to the embodiment of the present invention.

FIG. 3 is a cross sectional view showing the detailed structure of the internal combustion engine according to the first embodiment.

FIGS. 4(A) and 4(B) are graphs showing changes in the in-cylinder pressure in the case where gasoline is used as fuel and in the case where hydrogen is used as fuel respectively.

FIGS. 5(A) and 5(B) are graphs showing an example of relationship between the running condition of the internal combustion engine and the compression ratio, which serves as a basis for a map for gasoline fuel and a map for hydrogen fuel respectively in the first embodiment.

FIG. 6 is a graph illustrating a first high load range and maps to be used in the first embodiment.

FIG. 7 is a cross sectional view showing the detailed structure of an internal combustion engine according to a second embodiment.

FIG. 8 is a graph showing relationship between the air fuel ratio and the NOx emission amount in the internal combustion engine in the case where hydrogen is used as fuel.

### BEST MODE FOR CARRYING OUT THE INVENTION

In the following, the best mode for carrying out the present invention will be described in detail by way of example with reference to the accompanying drawings.

### First Embodiment

The internal combustion engine 1 that will be described in the following is a variable compression ratio internal combustion engine, in which the compression ratio is changed by displacing a cylinder block 3 having cylinders 2, along the direction of center axes of the cylinders 2, relative to a crankcase 4 to which pistons are linked.

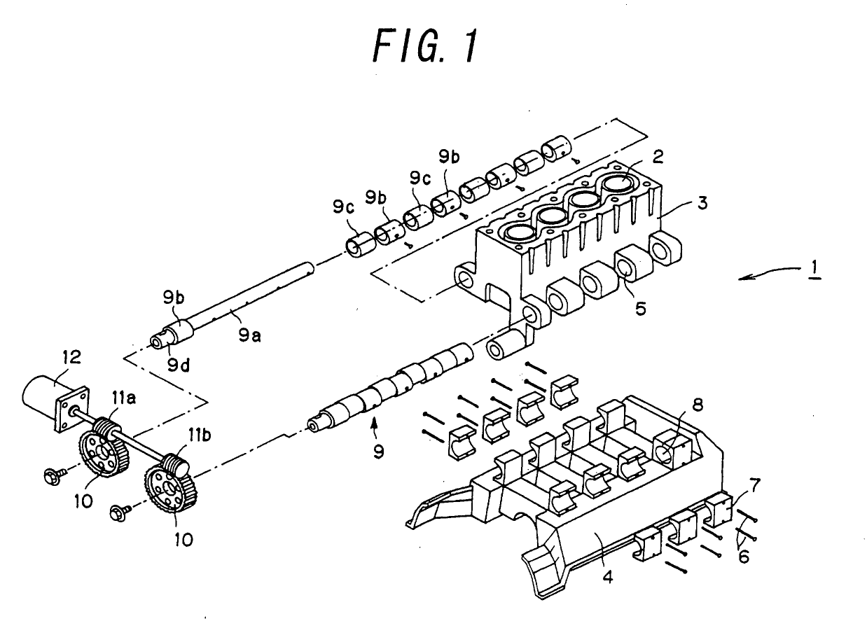

First, the structure of the variable compression ratio internal combustion engine according to this embodiment will be described with reference to FIG. 1. As shown in FIG. 1, the cylinder block 3 has a plurality of projecting portions formed on both the lower sides thereof. Each projecting portion has a bearing receiving bore 5 formed therein. The bearing receiving bore 5 is cylindrical in shape and extending perpendicularly to the axial direction of the cylinders 2 and parallel to the direction of arrangement of the multiple cylinders 2. The bearing receiving bores 5 on one side are arranged coaxially, and a pair of axes of the bearing receiving bores 5 on both sides of the cylinder block 3 are parallel to each other.

The crankcase 4 has standing wall portions to be placed between the above-mentioned projecting portions that have the bearing receiving bores 5. On the outwardly facing (with respect to the crankcase 4) surface of each standing wall portion, there is a semi-cylindrical recess. Caps 7 that are to be attached to the respective standing wall portions by bolts 6 are also prepared. The cap 7 also has a semi-cylindrical recess. When the cap 7 is attached to each standing wall portion, a cam receiving bore 8 having a cylindrical shape is formed. The shape of the cam receiving bore 8 is the same as the above-mentioned bearing receiving bore 5.

Similarly to the bearing receiving bores 5, the cam receiving bores 8 are formed in such a way as to extend perpendicularly to the axial direction of the cylinders 2 and parallel to the direction of arrangement of the multiple cylinders 2 when the cylinder block 3 is attached to the crankcase 4. These multiple cam receiving bores 8 also formed on both sides of the cylinder block 3, and the cam receiving bores 8 on one side are arranged coaxially. A pair of axes of the cam receiving bores 8 on both sides of the cylinder block 3 are parallel to each other. The distance between the bearing receiving bores 5 on one side and those on the other side is equal to the distance between the cam receiving bores 8 on one side and those on the other side.

A cam shafts 9 are respectively inserted in the two rows of the bearing receiving bores 5 and the cam receiving bores 8 that are alternately arranged. As shown in FIG. 1, the cam shaft 9 includes a shaft portion 9a, cam portions 9b, each having a perfect circular cam profile, that are fixed on the shaft portion 9a eccentrically with respect to the center axis of the shaft portion 9a and movable bearing portions 9c, each having the same outer profile as the cam portions 9b, that are rotatably attached on the shaft portion 9a. The cam portions 9b and the movable bearing portions 9c are arranged alternately. The two cam shafts 9 are mirror images to each other. On one end of the cam shaft 9 is formed a mount portion 9d for a gear 10 (which will be described later). The center axis of the shaft portion 9a and the center of the mount portion 9d do not coincide with each other, and the center of the cam portions 9b and the center of the mount portion 9d coincide with each other.

The movable bearing portions 9c are also eccentric with respect to the shaft portion 9a, and their degree of eccentricity is the same as that of the cam portions 9b. In each of the cam shafts 9, the cam portions 9b are eccentric in the same direction. Since the outer profile of the movable bearing portions 9c is perfect circular with the diameter same as that of the cam portions 9b, it is possible to align the outer surfaces of the plurality of cam portions 9b and the outer surfaces of the plurality of movable bearing portions 9c.

A gear 10 is attached on one end of each cam shaft 9. The pair of gears 10 attached at ends of the pair of cam shafts 9 are in engagement with respective worm gears 11a and 11b. The worm gears 11a and 11b are mounted on a single output shaft of a single motor 12. The worm gears 11a and 11b have spiral groove with the spiral directions opposite to each other. Accordingly, as the motor 12 turns, the two cam shafts 9 are rotated by the gears 10 in the directions opposite to each other. The motor 12 is fixedly mounted on the cylinder block 3 and moves integrally with it.

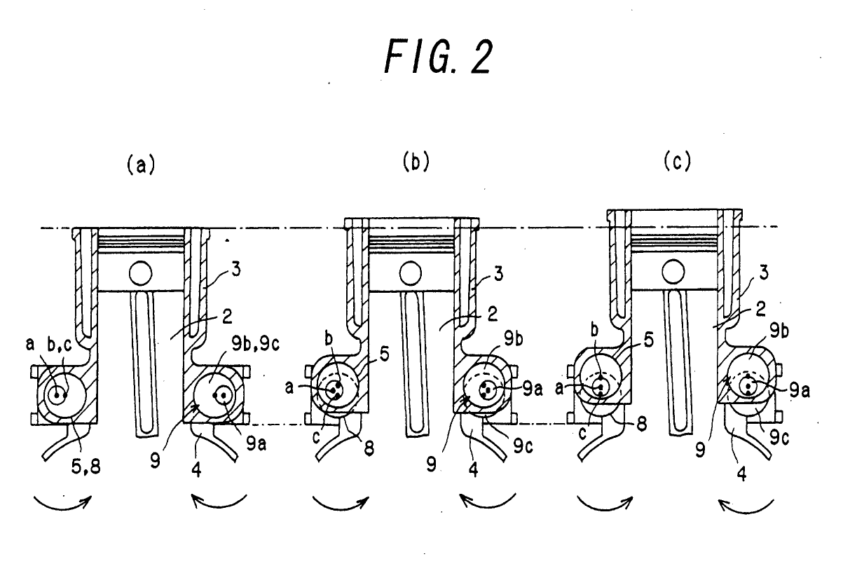

In the following, a method of controlling the compression ratio in the internal combustion engine 1 having the above-described structure will be described in detail. FIGS. 2(a) to 2(c) are cross sectional views that show relationship among the cylinder block 3, the crankcase 4 and the cam shafts 9 provided therebetween. In FIGS. 2(a) to 2(c), the center axis of the shaft portion 9a is designated by “a”, the center of the cam portions 9b is designated by “b”, and the center of the movable bearing portions 9c is designated by “c”. FIG. 2(a) shows a state in which the outer circumferences of all the cam portions 9b and the movable bearing portions 9c are aligned as seen from the direction along the shaft portion 9a. In this state, the two shaft portions 9a are located at outer positions in the bearing receiving bores 5 and the cam receiving bores 8.

When the shaft portions 9a are turned, by driving the motor 12, from the state shown in FIG. 2(a) in the direction indicated by arrows, the state shown in FIG. 2(b) is realized. Since the direction of eccentricity of the cam portions 9b and that of the movable bearing portions 9c with respect to the shaft portion 9a become different from each other through this turning process, the cylinder block 3 can be displaced relative to the crankcase 4 toward the top dead center side. The displacement amount becomes maximum when the cam shaft 9 is turned to the state shown in FIG. 2(c). In that state, the displacement amount is twice the amount of eccentricity of the cam portions 9b and the movable bearing portions 9c. The cam portions 9b and the movable bearing portions 9c rotate respectively in the interior of the cam receiving bores 8 and the bearing receiving bores 5 to allow displacement of the shaft portion 9a in the interior of the cam receiving bores 8 and the bearing receiving bores 5.

By using the above-described mechanism, it is possible to move the cylinder block 3 relative to the crankcase 4 along the axial direction of the cylinders 2, thereby making it possible to variably control the compression ratio.

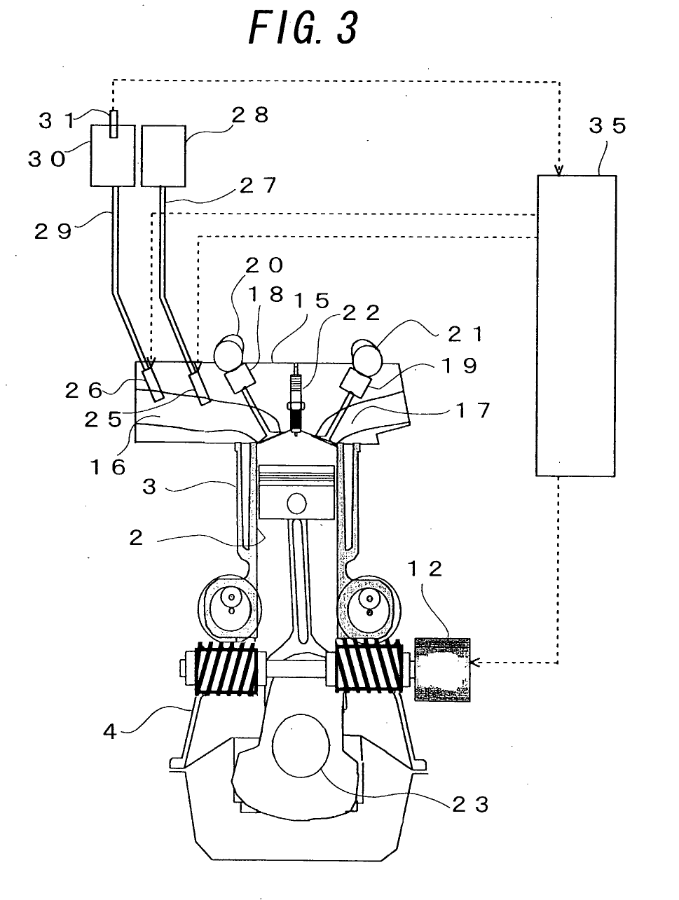

In the following, details of the internal combustion engine 1 according to this embodiment will be described. FIG. 3 is a cross sectional view showing the detailed structure of the internal combustion engine 1. In FIG. 3, a cylinder head 15 is attached on top of the cylinder block 3. The cylinder head 15 constitutes the top wall of the combustion chamber. In the cylinder head 15, there is provided an ignition plug 22 for igniting air-fuel mixture in the combustion chamber. An intake port 16 and an exhaust port 17 are also formed in the cylinder head 15. At portions of the intake port 16 and the exhaust port 17 that open to the combustion chamber, there is provided an intake valve 18 and an exhaust valve 19 respectively in such a way that they can reciprocate.

An intake valve cam 20 and an exhaust valve cam 21 for pressing respectively the intake valve 18 and the exhaust valve 19 to open them in synchronization with turning of the crankshaft 23 are provided above the intake valve 18 and the exhaust valve 19 respectively. In the intake port 16, there is provided a fuel injection valve for gasoline 25 for injecting gasoline as fuel and a fuel injection valve for hydrogen 26 for injecting hydrogen as fuel. The fuel injection valve for gasoline 25 is in communication with a gasoline tank 28 via a gasoline supply pipe 27. Gasoline stored in the gasoline tank 28 is pumped by a fuel pump that is not shown in the drawings and supplied to the fuel injection valve for gasoline 25 at a predetermined fuel pressure. On the other hand, the fuel injection valve for hydrogen 26 is in communication with a hydrogen tank 30 via a hydrogen supply pipe 29. Hydrogen stored in the hydrogen tank 30 is supplied to the fuel injection valve for hydrogen 26 at a predetermined hydrogen fuel pressure. The hydrogen fuel pressure corresponds to the fuel injection pressure of hydrogen as it is injected as fuel through the fuel injection valve for hydrogen 26. The hydrogen tank 30 is equipped with a pressure sensor 31, so that the pressure of the hydrogen stored in the hydrogen tank 30 can be detected.

An electronic control unit (ECU) 35 for controlling the internal combustion engine is annexed to the internal combustion engine 1 having the above-described structure. The ECU 35 is a unit that controls the running condition of the internal combustion engine 1 in accordance with running requirements of the internal combustion engine 1 and driver's demands and performs control of the compression ratio of the internal combustion engine 1 and control relating to fuel injection.

The ECU 35 is connected with a crank position sensor (not shown), an accelerator position sensor (not shown), the pressure sensor 31 and other various sensors relating to control of the running condition and compression ratio of the internal combustion engine 1 and control of fuel injection through electric wiring. Output signals of these sensors are input to the ECU 35. Further, the ECU 35 is connected with the fuel injection valve for gasoline 25 and the fuel injection valve for hydrogen 26 etc. in the internal combustion engine 1 through electric wiring, and in addition connected with a motor 12 for controlling the compression ratio in accordance with this embodiment through electric wiring so that it is controlled by the ECU 35.

The ECU 35 is equipped with a CPU, a ROM and a RAM etc. In the ROM, programs for performing various control of the internal combustion engine 1 and maps containing various data are stored. The programs stored in the ROM of the ECU 35 include routines for effecting compression ratio control and the fuel injection control according to this embodiment.

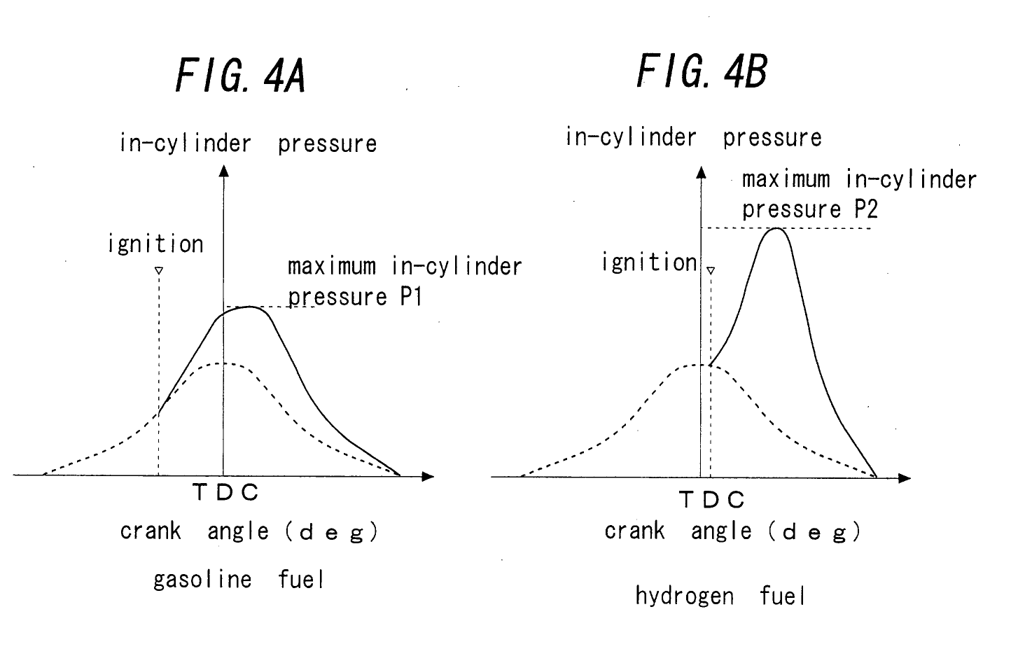

As described before, the internal combustion engine 1 according to this embodiment has a configuration that allows selective use of hydrogen and gasoline as fuel. Here, a difference in changes in the in-cylinder pressure inside the cylinder 2 between when gasoline is used as fuel and when hydrogen is used as fuel will be described in the following with reference to FIGS. 4(A) and 4(B). FIG. 4(A) shows changes in the in-cylinder pressure inside the cylinder 2 in the case in which gasoline is used as fuel, and FIG. 4(B) shows changes in the in-cylinder pressure in the case in which hydrogen is used as fuel. In these graphs, the horizontal axis represents the crank angle, and the vertical axis represents the in-cylinder pressure. The broken curves represent changes in the pressure in the case where combustion does not occur, namely changes in the pressure caused by movement of the piston in the cylinder 2. The solid curves represents the increase in the in-cylinder pressure caused by fuel combustion.

As will be understood from FIGS. 4(A) and 4(B), in the case where hydrogen is used as fuel, the combustion velocity is higher as compared to the case where gasoline is used, and accordingly, in the case where hydrogen is used as fuel, inclinations of the curve of the increase in the in-cylinder pressure caused by combustion is steeper as compared to the case where gasoline is used. The maximum in-cylinder pressure or the peak of the in-cylinder pressure is also higher in the case where hydrogen is used as fuel than in the case where gasoline is used as fuel (i.e. P2>P1). In addition, when hydrogen is used as fuel, thanks to steepness in the in-cylinder pressure increase curve, sufficient combustion will occur even if there is a delay in ignition time, and therefore, the ignition time is retarded to after top dead center.

It is known that the higher the combustion velocity in the internal combustion engine 1 is, the less likely knocking occurs. This is because when the combustion velocity is high, combustion is completed at an early time after ignition by the ignition plug 22, and risk of self ignition at an end portion of the cylinder 2 is low. This means that knocking is less likely to occur in the case where hydrogen is used as fuel than in the case where gasoline is used.

In view of the above fact, in this embodiment, when hydrogen is used as fuel, the compression ratio of the internal combustion engine 1 is set higher than in the case where gasoline is used. Specifically, two maps containing relationship between an environmental condition and/or running condition and the compression ratio of the internal combustion engine 1 are prepared, one being for hydrogen fuel and the other for gasoline fuel. When one of the fuels is used, a value of the compression ratio corresponding to the environmental condition and/or running condition is read out from the corresponding map and set as a target value of the compression ratio.

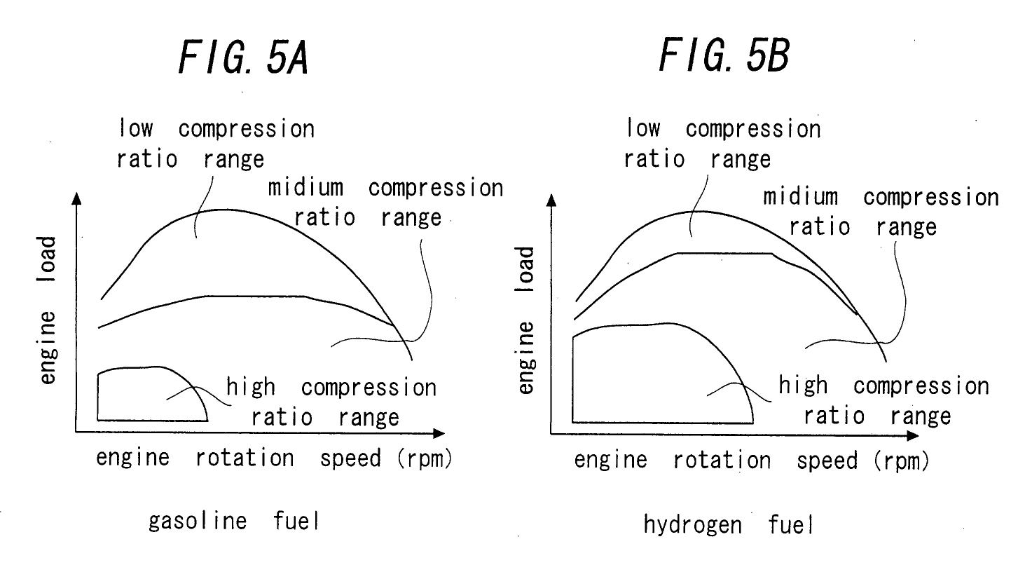

In the above-mentioned map for hydrogen fuel and the map for gasoline fuel, the compression ratio for the same environmental condition and/or running condition is made higher in the map for hydrogen fuel than in the map for gasoline fuel. Data contained in these maps is prepared in advance based on experiments. FIGS. 5(A) and 5(B) show an example of relationship between the running condition of the internal combustion engine 1 and the target compression ratio, which serves as a basis for the map for gasoline fuel and the map for hydrogen fuel in this embodiment. FIG. 5(A) shows relationship between the running condition of the internal combustion engine and the target compression ratio for the case where gasoline is used as fuel, and FIG. 5(B) shows relationship between the running condition of the internal combustion engine and the target compression ratio for the case where hydrogen is used as fuel. Although in the example shown in FIGS. 5(A) and 5(B) the value of the compression ratio is not varied depending on an environmental condition (for example, cooling water temperature), an environmental condition(s) may be introduced as a parameter(s) of the maps.

As described above, in this embodiment, since the compression ratio is set higher when hydrogen is used as fuel than when gasoline is used, it is possible to set an optimized compression ratio as a target value for each fuel, so that the engine efficiency of the internal combustion engine 1 can be enhanced for both the fuels. In this embodiment, the ECU 35 that effects the above described control constitutes a part of the fuel-suitable compression ratio changing means.

Next, another feature of the compression ratio control in this embodiment will be described. In FIGS. 4(A) and 4(B), in the case where hydrogen is used as fuel, the maximum in-cylinder pressure P2 is higher than the maximum in-cylinder pressure P1 in the case where gasoline is used as fuel as described before. Accordingly, when hydrogen is used as fuel, if the internal combustion engine 1 is in a high load running condition, the in-cylinder pressure may sometimes increase excessively to adversely affect reliability of mechanical components (such as the piston, cylinder bore, intake valve 18 and exhaust valve 19) related to the cylinder 2 of the internal combustion engine 1. To avoid such a situation, it will sometimes be necessary to enhance the mechanical strength or durability of the aforementioned mechanical components, which leads to an increase in the size of the components and an increase in the cost.

In view of the above, in this embodiment, when hydrogen is used as fuel, if the running condition of the internal combustion engine 1 falls within a first high load range, the compression ratio is decreased to lower the in-cylinder pressure of the cylinder 2 to a level that will not adversely affect reliability of the aforementioned mechanical components. Specifically, in the case where the running condition of the internal combustion engine 1 is in the first high load range, the aforementioned map from which the compression ratio corresponding to the environmental condition and/or the running condition is read out is changed from the map for hydrogen fuel to a map for hydrogen fuel under high load.

In the map for hydrogen fuel under high load and the map for hydrogen fuel, the compression ratio for the same environmental condition and/or running condition is lower in the map for hydrogen fuel under high load than in the map for hydrogen fuel.

The above-mentioned level of the in-cylinder pressure that does not adversely affect reliability of the mechanical components related to the cylinder 2 corresponds to the limit in-cylinder pressure. The aforementioned first high load range is such a range of the running condition of the internal combustion engine 1 in which it is considered that there is a possibility that the maximum in-cylinder pressure of the cylinder 2 exceeds the aforementioned limit in-cylinder pressure depending on the compression ratio. The first high load range is determined in advance by experiments.

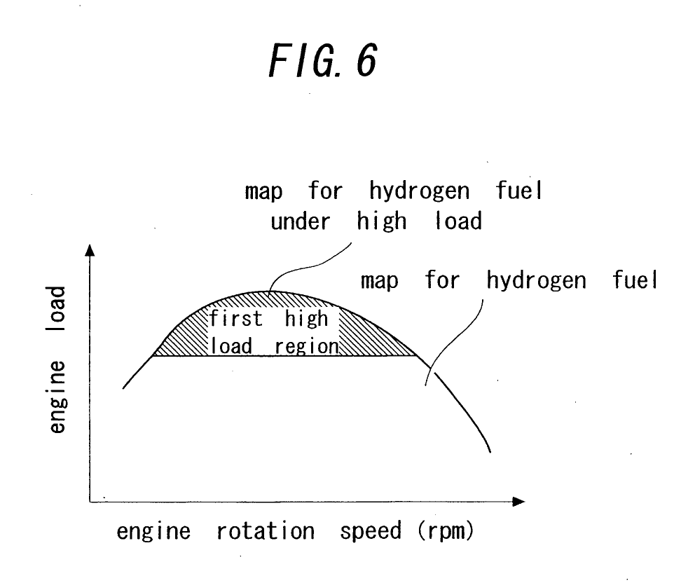

FIG. 6 shows the possible range of the running condition of the internal combustion engine 1 and the first high load range, wherein maps to be read out in the respective ranges are also indicated. As shown in FIG. 6, in the first high load range within the possible running condition of the internal combustion engine 1, the compression ratio is read out from the map for hydrogen fuel under high load, and in the other range, the compression ratio is read out from the map for hydrogen fuel.

Thus, when hydrogen is used as fuel and the internal combustion engine is in a high load running condition, the compression ratio is set lower, and therefore it is possible to prevent the in-cylinder pressure of the cylinder 2 from becoming excessively high. Accordingly, it is possible to suppress adverse effects on reliability of mechanical components relating to the cylinder 2.

In the above case, fuel ignition time may be further retarded in addition to setting the compression ratio lower. As shown in FIGS. 4(A) and 4(B), in the case where hydrogen is used as fuel, ignition is effected at a time after top dead center. Therefore, if the ignition time is further retarded, the in-cylinder pressure caused by piston movement is decreased. As a result, even if the increase in the in-cylinder pressure caused by combustion of hydrogen fuel is the same, the maximum in-cylinder pressure in total can be made lower.

By adopting the above feature in addition to selecting the map for hydrogen fuel under high load as the map from which the compression ratio is read out, it is possible to prevent more effectively the in-cylinder pressure of the cylinder 2 from becoming excessively high. Accordingly, it is possible to suppress adverse effects on reliability of mechanical components relating to the cylinder 2 more reliably.

Next, another characterizing feature of the compression ratio control in this embodiment will be described. Hydrogen as fuel is stored in the hydrogen tank 30 as described before, and the hydrogen is supplied from the hydrogen tank 30 to the fuel injection valve for hydrogen 26 while its pressure is controlled to a predetermined hydrogen pressure by a regulator (not shown) provided in the hydrogen supply pipe 29. However, as the amount of the hydrogen remaining in the hydrogen tank 30 decreases, there arises a risk that the hydrogen injection pressure at the fuel injection valve for hydrogen 26 may decrease, in spite of the pressure regulation by the regulator.

If this occurs, fuel injected through the fuel injection valve for hydrogen 26 may be ignited in some cases before sufficiently spreading in the cylinder 2. Then, knocking is more likely to occur. In view of this, in this embodiment, the pressure sensor 31 is provided in the hydrogen tank 30, and the compression ratio is varied in accordance with the output value of the pressure sensor 31.

Specifically, a compression ratio correction map that contains relationship between outputs of the pressure sensor 31 and correction coefficients for the compression ratio is prepared in advance, and a correction coefficient corresponding to the output of the pressure sensor 31 is read out from the compression ratio correction map. Thus, the target value of the compression ratio is determined as the product of the correction coefficient read out from the compression ratio correction map and the compression ratio read out from the map for hydrogen fuel or the map for hydrogen fuel under high load.

More specifically, the smaller the output value of the pressure sensor 31 is, the smaller the correction coefficient is made to set the smaller compression ratio, since the more likely knocking tends to occur.

In this way, it is possible to control the compression ratio appropriately regardless of the amount of hydrogen remaining in the hydrogen tank 30, and it is possible to prevent knocking of the internal combustion engine 1 effectively. Although in this embodiment the pressure sensor 31 is provided in the hydrogen tank 30, a pressure sensor may alternatively be provided in the fuel injection valve for hydrogen 26 to directly detect the hydrogen injection pressure at the fuel injection valve for hydrogen 26.

Although in this feature the compression ratio is varied by multiplying compression ratio data read out from the map for hydrogen fuel or the map for hydrogen fuel under high load by a correction coefficient, the compression ratio may be varied by changing the map from which a target value of the compression ratio is read out in accordance with the output of the pressure sensor 31.

### Second Embodiment

In the following, the second embodiment of the present invention will be described. In the second embodiment, a description will be made of compression ratio control in the case of the internal combustion engine 1 that is equipped with a direct-injection fuel injection valve for hydrogen 33 for injecting hydrogen as fuel directly into the cylinder 2 in addition to a fuel injection valve for hydrogen 26 for injecting hydrogen as fuel into the intake port 16.

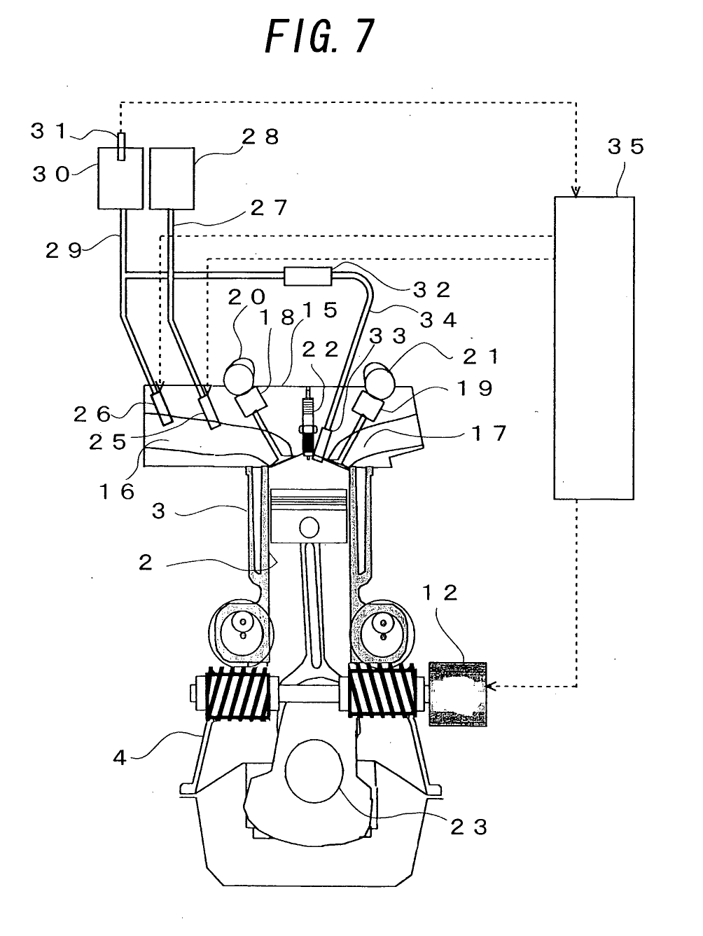

FIG. 7 is a cross sectional view showing the detailed structure of the internal combustion engine 1 according to the present invention. In this embodiment, a direct-injection fuel injection valve for hydrogen 33 is provided on the top wall of the combustion chamber of the internal combustion engine 1. The direct-injection fuel injection valve for hydrogen 33 is connected with a direct injection hydrogen supply pipe 34. The other end of the direct injection hydrogen supply pipe 34 is connected to a hydrogen supply pipe 29. In the halfway of the direct injection hydrogen supply pipe 34, there is provided a high pressure regulator 32. The high pressure regulator 32 is provided to inject the hydrogen with higher injection pressure when hydrogen as fuel is directly injected into the cylinder 2.

In this internal combustion engine 1, when hydrogen as fuel is injected through the fuel injection valve for hydrogen 26, hydrogen and air are appropriately mixed in the intake port 16, and therefore stable combustion is realized. On the other hand, when hydrogen as fuel is injected directly into the cylinder 2 through the direct-injection fuel injection valve for hydrogen 33, the efficiency of fuel filling can be enhanced, and it is possible to improve gas mileage. In this embodiment, these two ways of fuel injection are used properly depending on environmental conditions such as the engine temperature and/or the running condition. In this embodiment, the first fuel injection means includes the direct-injection fuel injection valve for hydrogen 33, and the second fuel injection means includes the fuel injection valve for hydrogen 26.

Here, in the case where fuel is injected through the direct-injection fuel injection valve for hydrogen 33, knocking is sometimes likely to occur especially when the running condition of the internal combustion engine 1 is in the high load range, since the amount of the fuel filling the cylinder 2 is large, and since fuel and air are not mixed as appropriately as in the case where injection is effected through the fuel injection valve for hydrogen 26. In addition, there is a risk that the maximum in-cylinder pressure of the cylinder 2 can become excessively high. In view of the above, in this embodiment, in the case where the running condition of the internal combustion engine 1 is in a second high load range and fuel is injected directly into the cylinder 2 through the direct-injection fuel injection valve for hydrogen 33, the compression ratio is set lower than that in the case where fuel is injected into the intake port 16 through the fuel injection valve for hydrogen 26.

The aforementioned second high load range is such a range of the running condition of the internal combustion engine 1 in which it is considered that if fuel is injected directly into the cylinder 2 through the direct-injection fuel injection valve for hydrogen 33, there is a risk that knocking can occur or the maximum in-cylinder pressure can become excessively high depending on the compression ratio. The second high load range is determined in advance by experiments.

Specifically, two maps containing relationship between an environmental condition and/or running condition and the compression ratio of the internal combustion engine 1 are prepared, one being for the case where fuel is injected through the fuel injection valve for hydrogen 26 (which map will be referred to as “the map for port injection” hereinafter) and the other for the case where fuel is injected through the direct-injection fuel injection valve for hydrogen 33 (which map will be referred to as “the map for direct injection” hereinafter). When one of the fuel injection valves is used, a value of the compression ratio corresponding to the environmental condition and/or the running condition is read out from the corresponding map and set as a target value.

In the above-mentioned map for port injection and the map for direct injection, the compression ratio for the same environmental condition and/or running condition is made lower in the map for direct injection than in the map for port injection. Data contained in these maps is prepared in advance based on experiments.

As described above, in the case where hydrogen as fuel is injected directly into the cylinder 2, the compression ratio is set low as compared to the case where hydrogen as fuel is injected into the intake port. Thus, it is possible to choose the optimum compression ratio regardless of which fuel injection valve is used to inject fuel, and therefore it is possible to enhance the efficiency of the internal combustion engine. In the above-described control, switching between the fuel injection valve for hydrogen 26 and the direct-injection fuel injection valve for hydrogen 33 in injecting hydrogen as fuel and switching between the maps from which a target value of the compression ratio is read out may be effected simultaneously, or alternatively one switching may be effected dependently following the other.

### Third Embodiment

In the following, the third embodiment of the present invention will be described. In the third embodiment, a description will be made of a control in which when the internal combustion engine 1 uses hydrogen as fuel and the amount of NOx emission from the internal combustion engine 1 is larger than a limit NOx emission amount, the air-fuel ratio is made leaner or richer depending on the air-fuel ratio of the internal combustion engine 1 at that time and the compression ratio is decreased to reduce the NOx emission amount. The detailed structure of the internal combustion engine 1 is the same as that shown in FIG. 3, and therefore a description thereof will be omitted.

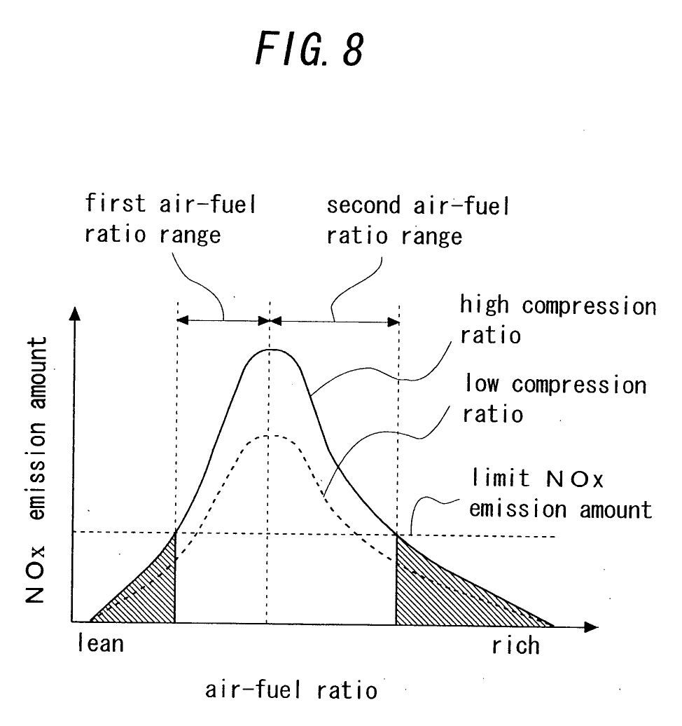

FIG. 8 is a graph showing relationship between the air-fuel ratio in the internal combustion engine 1 and the NOx emission amount when hydrogen is used as fuel. As shown in FIG. 8, when hydrogen is used as fuel, as the air-fuel ratio changes from the lean side to the rich side, the NOx emission amount increases and once comes to its peak. And as the air-fuel ratio further changes toward the rich side, the NOx emission amount decreases.

Here, the aforementioned limit NOx emission amount is a limit of the amount of NOx emitted from the internal combustion engine 1 that is allowable from a viewpoint concerning environmental pollution. In the course of change of the air-fuel ratio from the lean side to the rich side shown in FIG. 8, a first air-fuel ratio range is defined as the range extending between the air-fuel ratio at which the NOx emission amount first exceeds the limit NOx emission amount and the air-fuel ratio at which the NOx emission amount comes to the peak. In addition, a second air-fuel ratio range is defined as the air-fuel ratio range extending between the air-fuel ratio at which the NOx emission amount comes to the peak and the air-fuel ratio at which the NOx emission amount becomes lower than the limit NOx emission amount again as the air-fuel ratio further changes toward the rich side.

It is known that when the compression ratio of the internal combustion engine is made lower, the overall NOx emission amount can be reduced as shown in FIG. 8.

In this embodiment, when the air-fuel ratio in the internal combustion engine 1 falls within the first air-fuel ratio range, the air-fuel ratio is made leaner and the compression ratio is made lower to make the NOx emission amount lower than the limit NOx emission amount. When the air-fuel ratio falls within the second air-fuel ratio range, the air-fuel ratio is made richer and the compression ratio is made lower to make the NOx emission amount lower than the limit NOx emission amount.

With the above feature, it is possible to reduce the NOx emission amount more reliably as compared to the case where the NOx is reduced simply by making the air-fuel ratio richer or leaner, since an additional decrease in the NOx emission amount achieved by reduction of compression ratio can be expected. In addition, by effecting control to decrease the compression ratio additionally, it is possible to extend the range within which the air-fuel ratio should fall in order to make the NOx emission amount lower than the limit NOx emission amount. Thus, restriction on the air-fuel ratio in the internal combustion engine 1 may be relaxed.

In this embodiment, the NOx emission amount is reduced by making the air fuel ratio richer or leaner according to the air-fuel ratio of the internal combustion engine 1 and decreasing the compression ratio. However, in the case where the NOx emission amount exceeds the limit NOx emission amount only by a small amount, the NOx emission amount may be reduced only by effecting control to decrease the compression ratio. In this case, the NOx emission amount can be reduced by simpler control.

Although the above descriptions of the embodiments have been directed to cases where gasoline and hydrogen are used in combination as two types of fuels, the concept of the present invention may be applied to a combination of other two types of fuels or more than two types of fuels.

### INDUSTRIAL APPLICABILITY

According to the present invention, in a variable compression ratio internal combustion engine in which the compression ratio of the internal combustion engine can be varied and multiple types of fuels having different combustion velocities are used, it is possible to realize excellent engine performance for both the fuels.

1. A variable compression ratio internal combustion engine in which the compression ratio of the internal combustion engine can be varied and multiple types of fuels having different combustion velocities are used, wherein the internal combustion engine is provided with a fuel-suitable compression ratio changing section for changing the compression ratio of said internal combustion engine in accordance with the combustion velocity of the fuel used.

2. A variable compression ratio internal combustion engine according to claim 1 wherein said multiple types of fuels include hydrogen and a specific petroleum fuel, and said fuel-suitable compression ratio changing section makes the compression ratio of said internal combustion engine higher in the case where hydrogen is used as fuel than in the case where said petroleum fuel is used under the same environmental condition and/or the same running condition.

3. A variable compression ratio internal combustion engine according to claim 2, wherein when hydrogen is used as fuel and the running condition of said internal combustion engine falls within a first specific high load range, said fuel-suitable compression ratio changing section sets the compression ratio of said internal combustion engine to such a compression ratio that does not cause in-cylinder pressure of said internal combustion engine to exceed a limit in-cylinder pressure.

4. A variable compression ratio internal combustion engine according to claim 2, wherein when hydrogen is used as fuel and the running condition of said internal combustion engine falls within a first specific high load range, said fuel-suitable compression ratio changing section sets the compression ratio of said internal combustion engine to a compression ratio that does not cause in-cylinder pressure of said internal combustion engine to exceed a limit in-cylinder pressure, and fuel ignition time in said internal combustion engine is retarded.

5. A variable compression ratio internal combustion engine according to claim 2, wherein the internal combustion engine is further provided with a first fuel injection unit for injecting fuel directly into a cylinder of said internal combustion engine and a second fuel injection unit for injecting fuel into an intake port of said internal combustion engine, and when hydrogen is used as fuel and the running condition of said internal combustion engine falls at least within a second specific high load range, said fuel-suitable compression ratio changing section sets the compression ratio of said internal combustion engine lower in the case where fuel is injected through said first fuel injection unit than in the case where fuel is injected through said second fuel injection unit under the same environmental condition and/or the same running condition.

6. A variable compression ratio internal combustion engine according to claim 2, wherein when hydrogen is used as fuel and the air-fuel ratio of air-fuel mixture supplied to a cylinder of said internal combustion engine falls within such a first specific air-fuel ratio range in which the amount of NOx emission from said internal combustion engine is larger than a specific limit NOx amount and the amount of NOx emission increases as said air-fuel ratio becomes richer, said air-fuel mixture supplied to a cylinder of said internal combustion engine is made leaner and the compression ratio of said internal combustion engine is made lower by said fuel-suitable compression ratio changing section, thereby making said amount of NOx emission smaller than said limit NOx amount.

7. A variable compression ratio internal combustion engine according to claim 2, wherein when hydrogen is used as fuel and the air-fuel ratio of air-fuel mixture supplied to a cylinder of said internal combustion engine falls within such a second specific air-fuel ratio range in which the amount of NOx emission from said internal combustion engine is larger than a specific limit NOx amount and the amount of NOx emission decreases as said air-fuel ratio becomes richer, said air-fuel mixture supplied to a cylinder of said internal combustion engine is made richer and the compression ratio of said internal combustion engine is made lower by said fuel-suitable compression ratio changing section, thereby making said amount of NOx emission smaller than said limit NOx amount.

8. A variable compression ratio internal combustion engine according to claim 2, wherein said hydrogen as fuel is stored in a hydrogen tank and injected into a cylinder or an intake port of said internal combustion engine at a certain hydrogen injection pressure, and when hydrogen is used as fuel, said fuel-suitable compression ratio changing section changes the compression ratio of said internal combustion engine in accordance with said hydrogen injection pressure and/or the pressure in said hydrogen tank.

9. A variable compression ratio internal combustion engine according to claim 3, wherein the internal combustion engine is further provided with a first fuel injection unit for injecting fuel directly into a cylinder of said internal combustion engine and a second fuel injection unit for injecting fuel into an intake port of said internal combustion engine, and when hydrogen is used as fuel and the running condition of said internal combustion engine falls at least within a second specific high load range, said fuel-suitable compression ratio changing section sets the compression ratio of said internal combustion engine lower in the case where fuel is injected through said first fuel injection unit than in the case where fuel is injected through said second fuel injection unit under the same environmental condition and/or the same running condition.

10. A variable compression ratio internal combustion engine according to claim 3, wherein when hydrogen is used as fuel and the air-fuel ratio of air-fuel mixture supplied to a cylinder of said internal combustion engine falls within such a first specific air-fuel ratio range in which the amount of NOx emission from said internal combustion engine is larger than a specific limit NOx amount and the amount of NOx emission increases as said air-fuel ratio becomes richer, said air-fuel mixture supplied to a cylinder of said internal combustion engine is made leaner and the compression ratio of said internal combustion engine is made lower by said fuel-suitable compression ratio changing section, thereby making said amount of NOx emission smaller than said limit NOx amount.

11. A variable compression ratio internal combustion engine according to claim 3, wherein when hydrogen is used as fuel and the air-fuel ratio of air-fuel mixture supplied to a cylinder of said internal combustion engine falls within such a second specific air-fuel ratio range in which the amount of NOx emission from said internal combustion engine is larger than a specific limit NOx amount and the amount of NOx emission decreases as said air-fuel ratio becomes richer, said air-fuel mixture supplied to a cylinder of said internal combustion engine is made richer and the compression ratio of said internal combustion engine is made lower by said fuel-suitable compression ratio changing section, thereby making said amount of NOx emission smaller than said limit NOx amount.

12. A variable compression ratio internal combustion engine according to claim 4, wherein the internal combustion engine is further provided with a first fuel injection unit for injecting fuel directly into a cylinder of said internal combustion engine and a second fuel injection unit for injecting fuel into an intake port of said internal combustion engine, and when hydrogen is used as fuel and the running condition of said internal combustion engine falls at least within a second specific high load range, said fuel-suitable compression ratio changing section sets the compression ratio of said internal combustion engine lower in the case where fuel is injected through said first fuel injection unit than in the case where fuel is injected through said second fuel injection unit under the same environmental condition and/or the same running condition.

13. A variable compression ratio internal combustion engine according to claim 4, wherein when hydrogen is used as fuel and the air-fuel ratio of air-fuel mixture supplied to a cylinder of said internal combustion engine falls within such a first specific air-fuel ratio range in which the amount of NOx emission from said internal combustion engine is larger than a specific limit NOx amount and the amount of NOx emission increases as said air-fuel ratio becomes richer, said air-fuel mixture supplied to a cylinder of said internal combustion engine is made leaner and the compression ratio of said internal combustion engine is made lower by said fuel-suitable compression ratio changing section, thereby making said amount of NOx emission smaller than said limit NOx amount.

14. A variable compression ratio internal combustion engine according to claim 4, wherein when hydrogen is used as fuel and the air-fuel ratio of air-fuel mixture supplied to a cylinder of said internal combustion engine falls within such a second specific air-fuel ratio range in which the amount of NOx emission from said internal combustion engine is larger than a specific limit NOx amount and the amount of NOx emission decreases as said air-fuel ratio becomes richer, said air-fuel mixture supplied to a cylinder of said internal combustion engine is made richer and the compression ratio of said internal combustion engine is made lower by said fuel-suitable compression ratio changing section, thereby making said amount of NOx emission smaller than said limit NOx amount.

15. A variable compression ratio internal combustion engine according to claim 5, wherein when hydrogen is used as fuel and the air-fuel ratio of air-fuel mixture supplied to a cylinder of said internal combustion engine falls within such a first specific air-fuel ratio range in which the amount of NOx emission from said internal combustion engine is larger than a specific limit NOx amount and the amount of NOx emission increases as said air-fuel ratio becomes richer, said air-fuel mixture supplied to a cylinder of said internal combustion engine is made leaner and the compression ratio of said internal combustion engine is made lower by said fuel-suitable compression ratio changing section, thereby making said amount of NOx emission smaller than said limit NOx amount.

16. A variable compression ratio internal combustion engine according to claim 5, wherein when hydrogen is used as fuel and the air-fuel ratio of air-fuel mixture supplied to a cylinder of said internal combustion engine falls within such a second specific air-fuel ratio range in which the amount of NOx emission from said internal combustion engine is larger than a specific limit NOx amount and the amount of NOx emission decreases as said air-fuel ratio becomes richer, said air-fuel mixture supplied to a cylinder of said internal combustion engine is made richer and the compression ratio of said internal combustion engine is made lower by said fuel-suitable compression ratio changing section, thereby making said amount of NOx emission smaller than said limit NOx amount.

17. A variable compression ratio internal combustion engine according to claim 9, wherein when hydrogen is used as fuel and the air-fuel ratio of air-fuel mixture supplied to a cylinder of said internal combustion engine falls within such a first specific air-fuel ratio range in which the amount of NOx emission from said internal combustion engine is larger than a specific limit NOx amount and the amount of NOx emission increases as said air-fuel ratio becomes richer, said air-fuel mixture supplied to a cylinder of said internal combustion engine is made leaner and the compression ratio of said internal combustion engine is made lower by said fuel-suitable compression ratio changing section, thereby making said amount of NOx emission smaller than said limit NOx amount.

18. A variable compression ratio internal combustion engine according to claim 9, wherein when hydrogen is used as fuel and the air-fuel ratio of air-fuel mixture supplied to a cylinder of said internal combustion engine falls within such a second specific air-fuel ratio range in which the amount of NOx emission from said internal combustion engine is larger than a specific limit NOx amount and the amount of NOx emission decreases as said air-fuel ratio becomes richer, said air-fuel mixture supplied to a cylinder of said internal combustion engine is made richer and the compression ratio of said internal combustion engine is made lower by said fuel-suitable compression ratio changing section, thereby making said amount of NOx emission smaller than said limit NOx amount.

19. A variable compression ratio internal combustion engine according to claim 12, wherein when hydrogen is used as fuel and the air-fuel ratio of air-fuel mixture supplied to a cylinder of said internal combustion engine falls within such a first specific air-fuel ratio range in which the amount of NOx emission from said internal combustion engine is larger than a specific limit NOx amount and the amount of NOx emission increases as said air-fuel ratio becomes richer, said air-fuel mixture supplied to a cylinder of said internal combustion engine is made leaner and the compression ratio of said internal combustion engine is made lower by said fuel-suitable compression ratio changing section, thereby making said amount of NOx emission smaller than said limit NOx amount.

20. A variable compression ratio internal combustion engine according to claim 12, wherein when hydrogen is used as fuel and the air-fuel ratio of air-fuel mixture supplied to a cylinder of said internal combustion engine falls within such a second specific air-fuel ratio range in which the amount of NOx emission from said internal combustion engine is larger than a specific limit NOx amount and the amount of NOx emission decreases as said air-fuel ratio becomes richer, said air-fuel mixture supplied to a cylinder of said internal combustion engine is made richer and the compression ratio of said internal combustion engine is made lower by said fuel-suitable compression ratio changing section, thereby making said amount of NOx emission smaller than said limit NOx amount.
